(19) United States
(12) Patent Application Publication
(10) Pub. No.: US 2014/0118544 A1
(43) Pub. Date: May 1, 2014

(54) IMAGE SYNCHRONIZATION DEVICE AND SYSTEM

(71) Applicant: Kabushiki Kaisha Toshiba, Minato-ku (JP)

(72) Inventors: Saori Asaka, Kanagawa (JP); Takeshi Chujoh, Kanagawa (JP); Akiyuki Tanizawa, Kanagawa (JP); Hiroyuki Kobayashi, Chiba (JP)

(73) Assignee: Kabushiki Kaisha Toshiba, Minato-ku (JP)

(21) Appl. No.: 14/042,904

(22) Filed: Oct. 1, 2013

(30) Foreign Application Priority Data
Nov. 1, 2012 (JP) 2012-242023

(51) Int. Cl. H04N 7/18

(52) U.S. Cl. CPC H04N 7/183
USPC 348/143

(57) ABSTRACT

According to an embodiment, an image synchronization device includes an image capturing unit, a searching unit, and an output unit. The image capturing unit is configured to capture a first image while a mobile object on which the image capturing unit is mounted is running on a route. The searching unit is configured to acquire time-series second images captured by the image capturing unit while the mobile object was previously running on the route, obtain similarity between the first image and each of the second images, and search for a specific second image with the similarity satisfying criteria for select. The output unit is configured to output a synchronized image based on the first image and the specific second image.

### CROSS-REFERENCE TO RELATED APPLICATION

This application is based upon and claims the benefit of priority from Japanese Patent Application No. 2012-242023, filed on Nov. 1, 2012; the entire contents of which are incorporated herein by reference.

### FIELD

Embodiments described herein relate generally to an image synchronization device and an image synchronization system.

### BACKGROUND

Technologies for capturing images using a plurality of cameras, synchronizing images captured at the same capturing time or at the same capturing position and displaying the synchronized images are known.

### BRIEF DESCRIPTION OF THE DRAWINGS

FIG. 1 is a configuration diagram illustrating an example of an image synchronization device according to a first embodiment;

FIG. 2 is a diagram illustrating an example of time-series previous images according to the first embodiment;

FIG. 3 is a diagram illustrating an example of input images according to the first embodiment;

FIG. 4 is a diagram illustrating an example of a result of searching for predetermined previous images according to the first embodiment;

FIG. 5 is a diagram illustrating an example of a synchronized image according to the first embodiment;

FIG. 6 is a diagram illustrating an example of a synchronized image according to the first embodiment;

FIG. 7 is a diagram illustrating an example of a synchronized image according to the first embodiment;

FIG. 8 is a diagram illustrating an example of a synchronized image according to the first embodiment;

FIG. 9 is a diagram illustrating an example of a synchronized image according to the first embodiment;

FIG. 10 is a diagram illustrating an example of a synchronized image according to the first embodiment;

FIG. 11 is a flowchart illustrating an example of an image synchronization process according to the first embodiment;

FIG. 12 is a flowchart illustrating an example of a first search process according to the first embodiment;

FIG. 13 is a flowchart illustrating an example of a second or subsequent search process according to the first embodiment;

FIG. 14 is a flowchart illustrating another example of the first search process according to the first embodiment;

FIG. 15 is a flowchart illustrating another example of the second or subsequent search process according to the first embodiment;

FIG. 16 is a flowchart illustrating another example of the first search process according to the first embodiment;

FIG. 17 is a flowchart illustrating another example of the second or subsequent search process according to the first embodiment;

FIG. 18 is a diagram illustrating an example of a result of searching for predetermined previous images in a case where the number of frames of the previous images is larger than that of input images in the first embodiment;

FIG. 19 is a diagram illustrating an exemplary configuration of a generating unit according to a second embodiment;

FIG. 20 is a diagram illustrating an example of synchronized images according to the second embodiment;

FIG. 21 is a diagram illustrating an example of synchronized images according to the second embodiment;

FIG. 22 is a diagram illustrating an exemplary configuration of an image synchronization device according to a third embodiment;

FIG. 23 is a diagram illustrating an exemplary configuration of an image synchronization device according to a fourth embodiment;

FIG. 24 is a diagram illustrating an exemplary configuration of an image synchronization device according to a fifth embodiment;

FIG. 25 is a diagram illustrating an exemplary configuration of an image synchronization device according to a sixth embodiment; and

FIG. 26 is a diagram illustrating an exemplary configuration of an image synchronization system according to a seventh embodiment.

### DETAILED DESCRIPTION

According to an embodiment, an image synchronization device includes an image capturing unit, a searching unit, and an output unit. The image capturing unit is configured to capture a first image while a mobile object on which the image capturing unit is mounted is running on a route. The searching unit is configured to acquire time-series second images captured by the image capturing unit while the mobile object was previously running on the route, obtain similarity between the first image and each of the second images, and search for a specific second image with the similarity satisfying criteria for select. The output unit is configured to output a synchronized image based on the first image and the specific second image.

Embodiments will be described below in detail with reference to the accompanying drawings.

An image synchronization device according to each of the following embodiments synchronizes an image captured while moving on a mobile object along a predetermined route at a certain point in the past and an image currently captured while moving on the mobile object along the route with each other and outputs the synchronized images.

For example, with an image synchronization device according to each of the following embodiments, an image capturing device mounted on a train captures time-series images of a track in advance while the train is running on the track and sequentially images of the track while the train is running on the track again for inspection of the track or the like. The image synchronization device then searches for an image similar to each of the images sequentially captured for inspection of the track among the time-series images captured in advance, synchronizes each image with the corresponding found image, and outputs the synchronized images.

Since the image synchronization device according to each of the following embodiments can synchronize images captured arbitrarily at capturing positions and at capturing times that are not determined in advance in this manner, the image synchronization device is suitable for such applications as inspection of a route on which a mobile object moves.

### First Embodiment

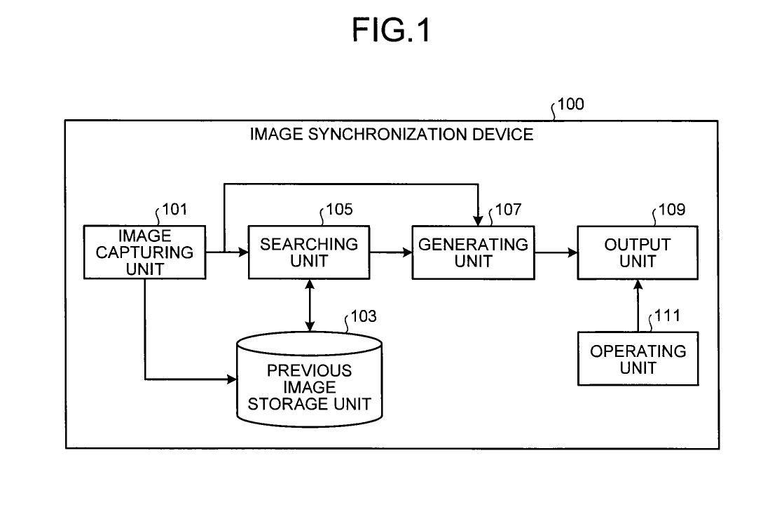

FIG. 1 is a configuration diagram illustrating an example of an image synchronization device 100 according to a first embodiment. As illustrated in FIG. 1, the image synchronization device 100 includes an image capturing unit 101, a previous image storage unit 103, a searching unit 105, a generating unit 107, an output unit 109, and an operating unit 111.

The image capturing unit 101 can be realized by an image capturing device such as a video camera or a digital camera, for example. The previous image storage unit 103 can be realized by a storage device that can magnetically, optically or electrically store information such as a hard disk drive (HDD), a solid state drive (SSD), a memory card, an optical disk, or a random access memory (RAM), for example. The searching unit 105 and the generating unit 107 may be implemented by making a processor such as a central processing unit (CPU) execute a program, that is, by software, may be implemented by hardware such as an integrated circuit (IC), or may be implemented by combination of software and hardware, for example. The output unit 109 may be realized by a display device such as a liquid crystal display or a touch panel display, may be realized by an audio output device such as a speaker, or may be realized by combination of these devices, for example. The operating unit 111 can be realized by an input device such as a mouse and a keyboard, for example.

The image capturing unit 101 is mounted on a mobile object (not illustrated) that runs on a predetermined route. The predetermined route may be a track, for example, and the mobile object may be a train, for example. In this case, since the train is not a commercial vehicle for transporting passengers and freight but a vehicle for operation for inspection of tracks or the like and image capturing is performed mainly on the tracks, the image capturing unit 101 is preferable to be mounted so as to image the forward running direction of the vehicle. Note that the path and the mobile object are not limited thereto, and may be any route or any mobile object as long as the mobile object moves on the route.

The image capturing unit 101 captures in advance time-series images (an example of second images) of a track while the train is running on the track at a certain point in the past. Hereinafter, time-series images captured at a certain point in the past may be referred to as time-series previous images. Note that the time-series previous images are used as reference images (images for comparison) for track inspection.

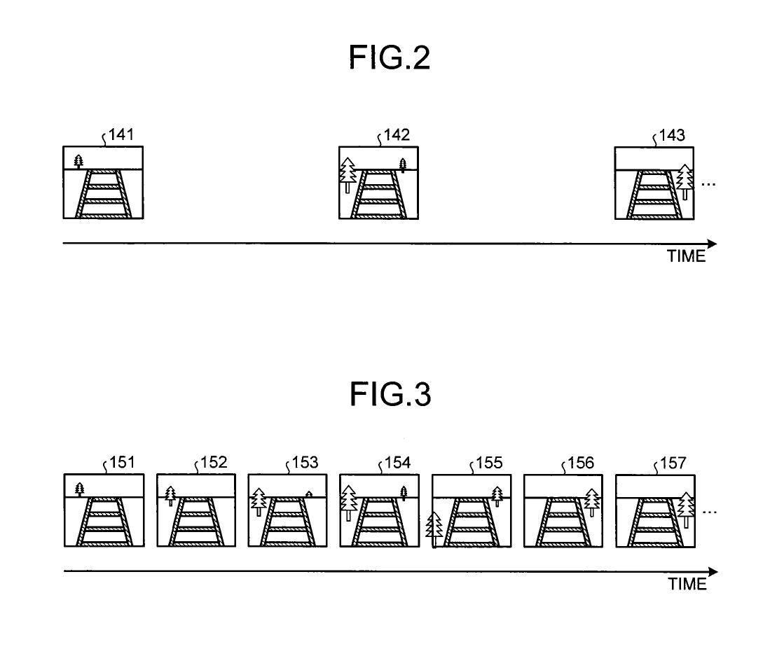

FIG. 2 is a diagram illustrating an example of the time-series previous images according to the first embodiment. In the example illustrated in FIG. 2, previous images 141 to 143, etc. are captured in time series (in time series of frames), and the previous images 141 to 143, etc. constitute the time-series previous images.

The image capturing unit 101 also sequentially captures images (an example of first images) of the track while the train is running on the track for inspection thereof. Examples of the inspection of a track include an inspection after a commercial vehicle causes an accident such as derailment, an inspection after occurrence of natural disaster such as earthquake, and a routine inspection, but the inspection is not limited thereto. Hereinafter, the images sequentially captured for inspection of a track may be referred to as input images. Note that the input images that are sequentially captured are used as imaged to be inspected that are compared with the previous images for inspection of a track.

FIG. 3 is a diagram illustrating an example of the input images according to the first embodiment. In the example illustrated in FIG. 3, input images 151 to 157, etc. are sequentially captured in time series (in time series of frames). Note that, since a case in which the running speed of the train while the input images are captured is slower than that while the previous images are captured is assumed in the first embodiment, the number of frames while the input images are captured is larger than that while the previous images are captured.

Since the image synchronization device 100 will be described below on the basis of the inspection of the track, the description will be made on the assumption that the inspection of the track corresponds to the current time.

The previous image storage unit 103 stores therein time-series previous images captured by the image capturing unit 101.

Input images captured at the current time by the image capturing unit 101 are sequentially input to the searching unit 105. Each time an input image is input from the image capturing unit 101, the searching unit 105 then acquires the time-series previous images from the previous image storage unit 103, and obtains the similarity between the input image and each of the previous images to search for a predetermined previous image with the similarity equal to or higher than a threshold. Note that, in the first embodiment, if no previous image with the similarity equal to or higher than the threshold is found, the searching unit 105 assumes a previous image with the highest similarity as the predetermined previous images and adds error information thereto. If not previous image with the similarity equal to or higher than the threshold is found, the searching unit 105 may add the error information to the input image instead of the predetermined previous image.

It is assumed here that the number of previous images to be acquired from the previous image storage unit 103, that is, the number of previous images included in (constituting) the time-series previous images is set in advance in the first embodiment, but the number of previous images is not limited thereto. Similarly, it is assumed that the threshold is set in advance in the first embodiment, but the threshold is not limited thereto. The number of previous images included in the time-series previous images is set in advance on the basis of experimental values or the like. Furthermore, the number of predetermined previous images is assumed to be one in the first embodiment, the number of predetermined previous images is not limited thereto. The searching unit 105 may find one or more predetermined previous images, and obtain one predetermined previous image by interpolation between the found one or more predetermined previous images.

Note that, each time an input image is input from the image capturing unit 101, the searching unit 105 acquires a preset number of previous images in the order of time series from the predetermined previous image found last time as the time-series previous image from the previous image storage unit 103. Thus, the time-series previous images acquired by the searching unit 105 are not always the same every time.

Furthermore, the searching unit 105 can obtain the similarity between an input image and a previous image by various techniques.

For example, the searching unit 105 obtains the similarity between an input image and a previous image from a differential value between pixels. The similarity between an input image and a previous image based on a differential value between pixels is obtained by Equation (1) and Equation (2), for example.

$$\begin{matrix}{Diff}_{sum} = \frac{1}{M \times N} {\sum }_{i = 1}^{M} {\sum }_{j = 1}^{N} \vert {I}_{i , j} - {P}_{i , j} \vert & ( 1 ) \\ Sim = ( {2}^{k} - 1 ) - {Diff}_{sum} & ( 2 )\end{matrix}$$

In Equation (1), I represents an input image, P represents a previous image, M and N represent the size of image regions for which the similarity is calculated, i and j are parameters representing pixel positions in the image regions for which the similarity is calculated, and Diffₛᵤₘ represents a differential values between pixels of the input image I and the previous image P. In Equation (2), k represents color depth, and Sim represents the similarity between the input image I and the previous image P.

Alternatively, for example, the searching unit 105 obtains the similarity between an input image and a previous image from the root mean square error between pixels. The similarity between an input image and a previous image based on the root mean square error between pixels is obtained by Equation (3) and Equation (4), for example.

$$\begin{matrix}RMSE = \sqrt{\frac{1}{M \times N} {\sum }_{i = 1}^{M} {\sum }_{j = 1}^{N} {\{ {I}_{i , j} - {P}_{i , j} \}}^{2}} & ( 3 ) \\ Sim = ( {2}^{k} - 1 ) - RMSE & ( 4 )\end{matrix}$$

In Equation (3), I, P, M, N, i and j represent the same as in Equation (1), and RMSE represents the root mean square error between pixels of the input image I and the previous image P. In Equation (4), k and Sim represent the same as in Equation (2).

Alternatively, for example, the searching unit 105 obtains the similarity between an input image and a previous image from the normalized cross correlation between pixels. The similarity between an input image and a previous image based on the normalized cross correlation between pixels is obtained by Equation (5), for example.

$${R}_{ZNCC} = \frac{MN {\sum }_{j = 0}^{N - 1} {\sum }_{i = 0}^{M - 1} I ( i , j ) P ( i , j ) - {\sum }_{j = 0}^{N - 1} {\sum }_{i = 0}^{M - 1} I ( i , j ) \times {\sum }_{j = 0}^{N - 1} {\sum }_{i = 0}^{M - 1} P ( i , j )}{\sqrt{\begin{matrix}( MN {\sum }_{j = 0}^{N - 1} {\sum }_{i = 0}^{M - 1} {I ( i , j )}^{2} - {( {\sum }_{j = 0}^{N - 1} {\sum }_{i = 0}^{M - 1} I ( i , j ) )}^{2} ) \\ ( MN {\sum }_{j = 0}^{N - 1} {\sum }_{i = 0}^{M - 1} {P ( i , j )}^{2} - {( {\sum }_{j = 0}^{N - 1} {\sum }_{i = 0}^{M - 1} P ( i , j ) )}^{2} )\end{matrix}}} \qquad ( 5 )$$

In Equation (5), I, P, M, N, i and j represent the same as in Equation (1), and R_{ZNCC} represents a normalized cross correlation coefficient between pixels of the input image I and the previous image P and can be used as the similarity between the input image I and the previous image P.

The searching unit 105 obtains the similarity between the input image and each of the previous images, compares the maximum similarity with a threshold, and determines a previous image with the similarity as the predetermined previous image if the similarity is equal to or higher than the threshold. If the highest similarity is lower than the threshold, however, the searching unit 105 determines the previous image with the similarity as the predetermined previous image and adds error information thereto.

The searching unit 105 may use any of the three techniques described above or may combine two or more of the three techniques described above to obtain the similarity between an input image and a previous image. Furthermore, the divisions in the equations of the three techniques described above may be replaced by preset values.

Although the threshold is preset in the first embodiment as described above, the searching unit 105 may obtain the threshold by using an average luminance value or a maximum luminance value of the input images and the previous images or may adjust the brightness of darker images by tone mapping or averaging when the brightness varies largely between the images.

When the brightness varies largely between the images, that is, when the relation of Iₘₐₓ>Pₘₐₓ or Iₘₐₓ<Pₘₐₓ is satisfied between the maximum pixel value Iₘₐₓ in an input image I and the maximum pixel value Pₘₐₓ in a previous image P, the threshold Th is obtained by Equation (6) or Equation (7).

$$\begin{matrix}Th = {Th}_{ini} \times ( 1 - \frac{\vert {I}_{ma x} - {P}_{ma x} \vert}{{2}^{k}} ) & ( 6 ) \\ Th = {Th}_{ini} - \frac{\vert {I}_{ma x} - {P}_{ma x} \vert}{{2}^{k }} & ( 7 )\end{matrix}$$

In Equations (6) and (7), Thᵢₙᵢ represents the threshold uniquely set in advance when the brightness of the input image I and that of the previous image P are equal to each other, and k represents color depth. Although the threshold Th is obtained from the maximum pixel value in Equations (6) and (7), the threshold Th may be obtained by using the average pixel value.

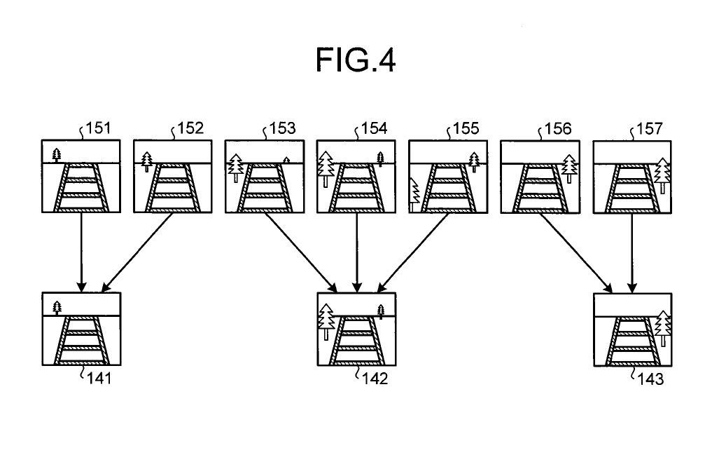

FIG. 4 is a diagram illustrating an example of a result of searching for predetermined previous images according to the first embodiment. In the example illustrated in FIG. 4, a predetermined previous image is searched for each of input images 151 to 157, and the predetermined previous image for the input images 151 and 152 is a previous image 141, the predetermined previous image for the input images 153 to 155 is a previous image 142, and the predetermined previous image for the input images 156 and 157 is a previous image 143.

The generating unit 107 generates synchronized images by using the input images input from the image capturing unit 101 and the predetermined previous images found by the searching unit 105. Specifically, the generating unit 107 generates an image in which an input image and a predetermined previous image are arranged, an image in which a differential image representing a difference between an input image and a predetermined previous image are arranged, an image that is a combination of a differential image and an input image, or the like as a synchronized image.

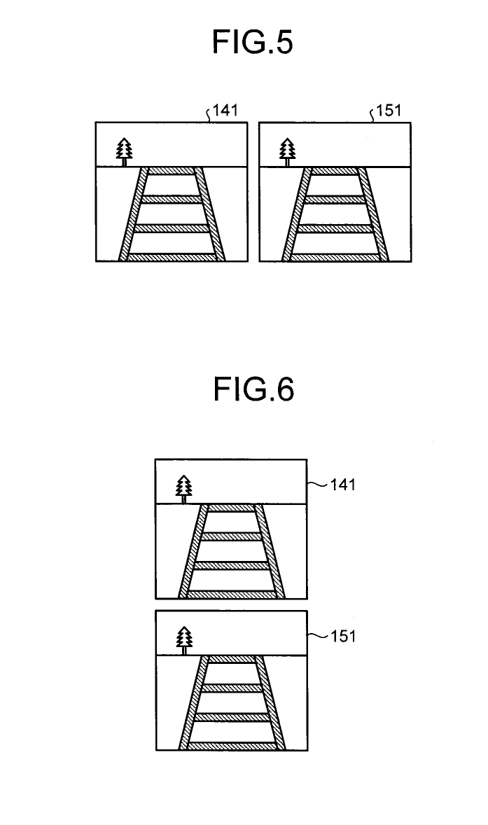

FIGS. 5 to 10 are diagrams illustrating examples of the synchronized images according to the first embodiment. A synchronized image illustrated in FIG. 5 is an image in which the predetermined previous image that is the previous image 141 and the input image 151 are arranged laterally. A synchronized image illustrated in FIG. 6 is an image in which the predetermined previous image that is the previous image 141 and the input image 151 are arranged vertically.

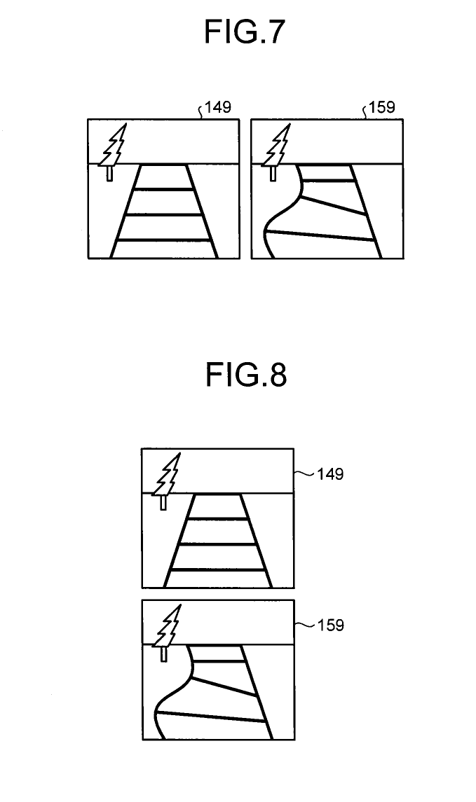

A synchronized image illustrated in FIG. 7 is an image in which the predetermined previous image that is the previous image 149 and the input image 159 are arranged laterally. A synchronized image illustrated in FIG. 8 is an image in which the predetermined previous image that is the previous image 149 and the input image 159 are arranged vertically. Note that the previous image 149 is a previous image with the maximum similarity to the input image 159, the similarity being lower than the threshold, that is, a previous image with error information added thereto. The error information, however, may be added to the input image 159 instead of the previous image 149.

In the synchronized images illustrated in FIGS. 5 to 8, the positions of the predetermined image and the input image may be reversed.

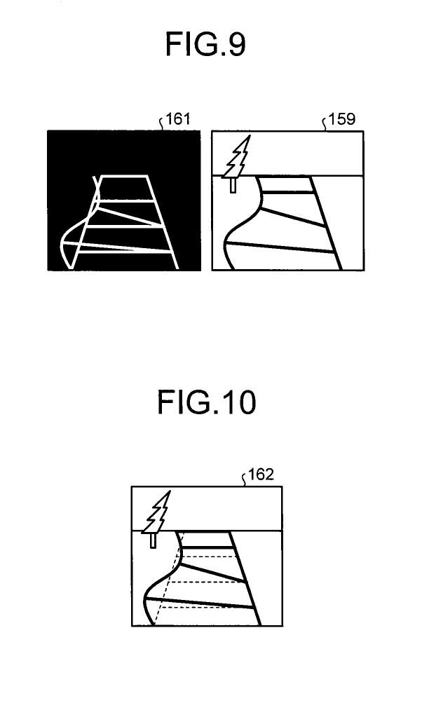

A synchronized image illustrated in FIG. 9 is an image in which a differential image 161 and the input image 159 are arranged laterally. The differential image 161 is an image presenting the difference between the previous image 149 that is the predetermined previous image and the input image 159. Note that the synchronized image illustrated in FIG. 9 may present the differential image 161 when the difference is equal to or larger than a certain value or present the predetermined previous image that is the previous image 149 when the difference is smaller than the certain value. In the synchronized image illustrated in FIG. 9, the positions of the differential image and the input image may be reversed, and the differential image and the input image may be arranged vertically instead of being arranged laterally.

A synchronized image illustrated in FIG. 10 is an image presenting a composite image 162 obtained by combining the differential image 161 with the input image 159.

The output unit 109 outputs synchronized images based on the input images input from the image capturing unit 101 and the predetermined previous images found by the searching unit 105. Specifically, the output unit 109 outputs for display a synchronized image generated by the generating unit 107 each time an input image is input from the image capturing unit 101.

Since an image in which an input image that is arbitrarily captured and a predetermined previous image are arranged is thus displayed as a synchronized image, the user (inspector) can compare the images to find out the difference of the input image from the predetermined previous image. In particular, if a composite image is displayed as a synchronized image, the difference of the input image from the predetermined previous image can be easily found out.

The operating unit 111 controls the display mode of the synchronized images displayed by the output unit 109 according to an operation input from the user (inspector). For example, the operating unit 111 performs display switching control of switching display of the output unit 109 from display of a synchronized image to display of an input image and scaling control of scaling up/down display of the output unit 109 around a position specified by the user as the center according to an operation input from the user. The operating unit 111 may also save an image displayed by the output unit 109 or save an image or pixel positions of a frame specified by the user according to an operation input from the user.

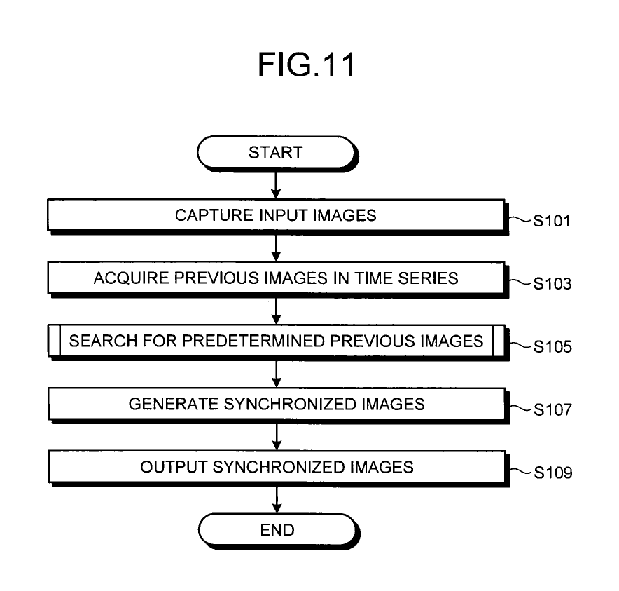

FIG. 11 is a flowchart illustrating an example of a flow of procedures of an image synchronization process performed by the image synchronization device 100 according to the first embodiment.

First, the image capturing unit 101 sequentially captures input images (step S101).

Subsequently, each time an input image is captured by the image capturing unit 101, the searching unit 105 acquires time-series previous images from the previous image storage unit 103 (step S103), obtains the similarity between the input image and each of the previous images, and searches for a predetermined previous image with a similarity equal to or higher than a threshold (step S105).

Subsequently, the generating unit 107 generates a synchronized image by using the input image input from the image capturing unit 101 and the predetermined previous image found by the searching unit 105 (step S107).

Subsequently, the output unit 109 outputs for display the synchronized image generated by the generating unit 107 (step S109).

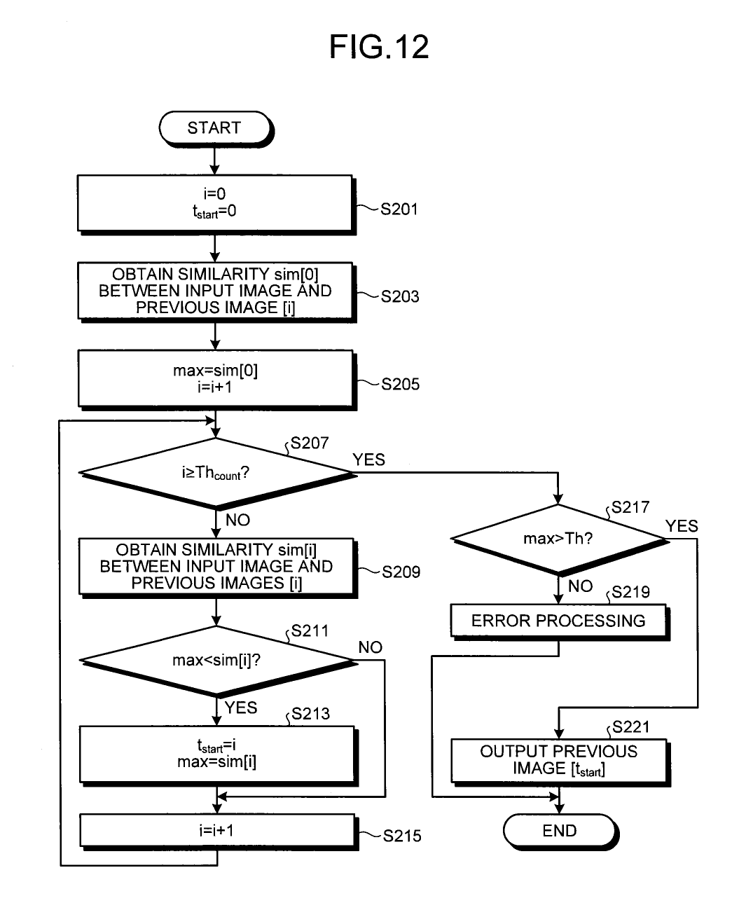

FIG. 12 is a flowchart illustrating an example of a flow of procedures of a first search process performed by the searching unit 105 according to the first embodiment, in which details of step S105 of the flowchart illustrated in FIG. 11 are illustrated. In the flowchart illustrated in FIG. 12, the similarity between an input image and each of previous images is obtained, the maximum similarity is compared with the threshold, and the previous image with the maximum similarity is determined to be the predetermined previous image if the maximum similarity is equal to or higher than the threshold. Note that, in the example illustrated in FIG. 12, it is assumed that the searching unit 105 has acquired Th_{count} previous images in the order of time series from the first previous image [0] as the time-series previous images among the time-series previous images stored in the previous image storage unit 103 in step S103 of the flowchart illustrated in FIG. 11. In the first embodiment, the value of Th_{count} is set in advance.

First, the searching unit 105 initializes a variable i and a variable tₛₜₐᵣₜ to 0 (step S201). Herein, i is a variable representing both a parameter for identifying a previous image and a count value, and tₛₜₐᵣₜ is a variable representing a previous image with the maximum similarity to the input image.

Subsequently, the searching unit 105 obtains the similarity sim[0] between the input image input from the image capturing unit 101 and a previous image [i] (step S203).

Subsequently, the searching unit 105 stores the value of the similarity sim[0] in a variable max and increments the variable i (step S205). Herein, max is a variable representing the maximum value of the similarity between an input image and previous images.

Subsequently, the searching unit 105 checks whether or not i≧Th_{count} is satisfied (step S207) and, if i≧Th_{count} is not satisfied (No in step S207), obtains the similarity sim[i] between the input image and a previous image [i] (step S209).

Subsequently, the searching unit 105 checks whether or not max<sim[i] is satisfied (step S211) and, if max<sim[i] is satisfied (Yes in step S211), updates the value of the variable tₛₜₐᵣₜ with the value of the variable i, and updates the value of the variable max with the value of the similarity sim[i] (step S213). If max<sim[i] is not satisfied (No in step S211), the searching unit 105 does not perform the processing in step S213.

Subsequently, the searching unit 105 increments the variable i (step S215), and the returns to step S207.

If, on the other hand, i≧Th_{count} is satisfied (Yes in step S207), the searching unit 105 checks whether or not max>Th is satisfied (step S217). If max>Th is satisfied (Yes in step S217), the searching unit 105 outputs the previous image [tₛₜₐᵣₜ] as the predetermined previous image to the generating unit 107 (step S221). Herein, Th is the threshold for the similarity.

If max>Th is not satisfied (No in step S217), the searching unit 105 performs error processing (step S219). Specifically, the searching unit 105 determines the previous image [tₛₜₐᵣₜ] as the predetermined previous image, and outputs the previous image [tₛₜₐᵣₜ] with error information to the generating unit 107.

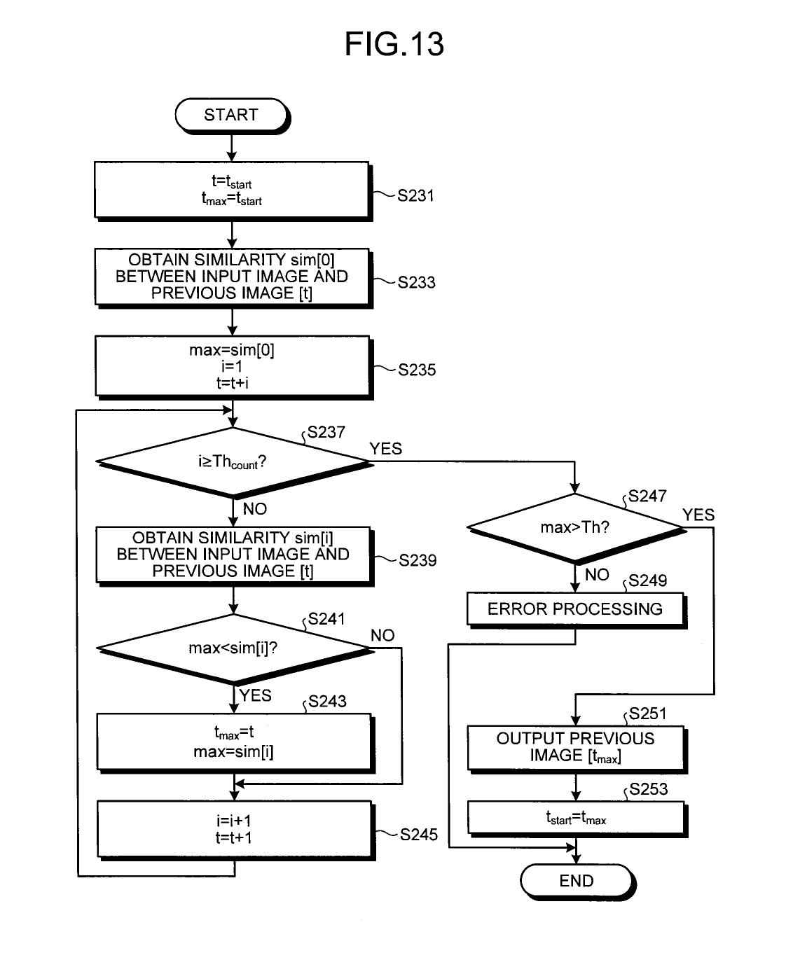

FIG. 13 is a flowchart illustrating an example of a flow of procedures of a second or subsequent search process performed by the searching unit 105 according to the first embodiment, in which details of step S105 of the flowchart illustrated in FIG. 11 are illustrated. Note that, in the example illustrated in FIG. 13, it is assumed that the searching unit 105 has acquired Th_{count} previous images in the order of time series from the previous image [tₛₜₐᵣₜ] as the time-series previous images among the time-series previous images stored in the previous image storage unit 103 in step S103 of the flowchart illustrated in FIG. 11. Alternatively, the searching unit 105 may set the beginning of the time-series previous images to be acquired to a previous image (a previous image [tₛₜₐᵣₜ−1] of one frame before, for example) captured some frames before the previous image [tₛₜₐᵣₜ] instead of the previous image [tₛₜₐᵣₜ].

First, the searching unit 105 initializes a variable t and a variable tₘₐₓ to the variable tₛₜₐᵣₜ (step S231). Herein, t is a variable for identifying a previous image, and tₘₐₓ is a variable representing a previous image with the maximum similarity to the input image. Note that, in the flowchart illustrated in FIG. 13, tₛₜₐᵣₜ is a variable representing the previous image with the maximum similarity to the input image in the previous search process.

Subsequently, the searching unit 105 obtains the similarity sim[0] between the input image input from the image capturing unit 101 and a previous image [t] (step S233).

Subsequently, the searching unit 105 stores the value of the similarity sim[0] in the variable max, initializes the variable i to 1, and increments the variable t (step S235). Herein, i is a variable used as a count value.

Subsequently, the searching unit 105 checks whether or not i≧Th_{count} is satisfied (step S237) and, if i≧Th_{count} is not satisfied (No in step S237), obtains the similarity sim[i] between the input image and a previous image [t] (step S239).

Subsequently, the searching unit 105 checks whether or not max<sim[i] is satisfied (step S241) and, if max<sim[i] is satisfied (Yes in step S241), updates the value of the variable tₘₐₓ with the value of the variable t, and updates the value of the variable max with the value of the similarity sim[i] (step S243). If max<sim[i] is not satisfied (No in step S241), the searching unit 105 does not perform the processing in step S243.

Subsequently, the searching unit 105 increments the variable i, increments the variable t (step S245), and returns to step S237.

If, on the other hand, i≧Th_{count} is satisfied (Yes in step S237), the searching unit 105 checks whether or not max>Th is satisfied (step S247). If max>Th is satisfied (Yes in step S247), the searching unit 105 outputs the previous image as the predetermined previous image to the generating unit 107 (step S251) and updates the value of the variable tₛₜₐᵣₜ with the value of the variable tₘₐₓ (step S253).

If max>Th is not satisfied (No in step S247), the searching unit 105 performs error processing (step S249). Specifically, the searching unit 105 determines the previous image [tₘₐₓ] as the predetermined previous image, outputs the previous image [tₘₐₓ] with error information to the generating unit 107, and updates the value of the variable tₛₜₐᵣₜ with the value of the variable tₘₐₓ.

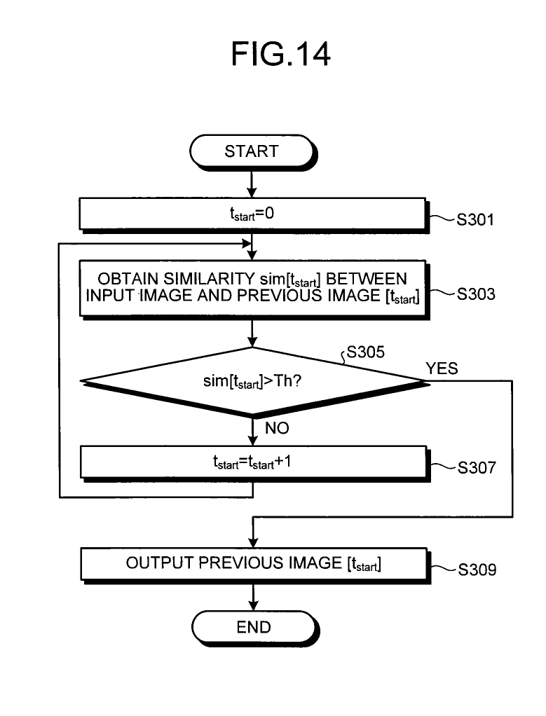

FIG. 14 is a flowchart illustrating another example of the flow of procedures of the first search process performed by the searching unit 105 according to the first embodiment, in which details of step S105 of the flowchart illustrated in FIG. 11 are illustrated. In the flowchart illustrated in FIG. 14, the similarity between an input image and a previous image is obtained, the similarity is compared with the threshold, and the previous image with the similarity is determined to be the predetermined previous image if the similarity is equal to or higher than the threshold. Note that, in the example illustrated in FIG. 14, it is assumed that the searching unit 105 has acquired previous images in the order of time series from the first previous image [0] as the time-series previous images from the previous image storage unit 103 in step S103 of the flowchart illustrated in FIG. 11.

First, the searching unit 105 initializes a variable tₛₜₐᵣₜ to 0 (step S301). Herein, tₛₜₐᵣₜ is a variable identifying a previous image.

Subsequently, the searching unit 105 obtains the similarity sim[tₛₜₐᵣₜ] between the input image input from the image capturing unit 101 and a previous image [tₛₜₐᵣₜ] (step S303).

Subsequently, the searching unit 105 checks whether or not sim[tₛₜₐᵣₜ]>Th is satisfied (step S305) and, if sim[tₛₜₐᵣₜ]>Th is satisfied (Yes in step S305), outputs the previous image [tₛₜₐᵣₜ] as the predetermined previous image to the generating unit 107 (step S309). Herein, Th is the threshold for the similarity.

If, on the other hand, sim[tₛₜₐᵣₜ]>Th is not satisfied (No in step S305), the searching unit 105 increments the variable tₛₜₐᵣₜ (step S307), and returns to step S303.

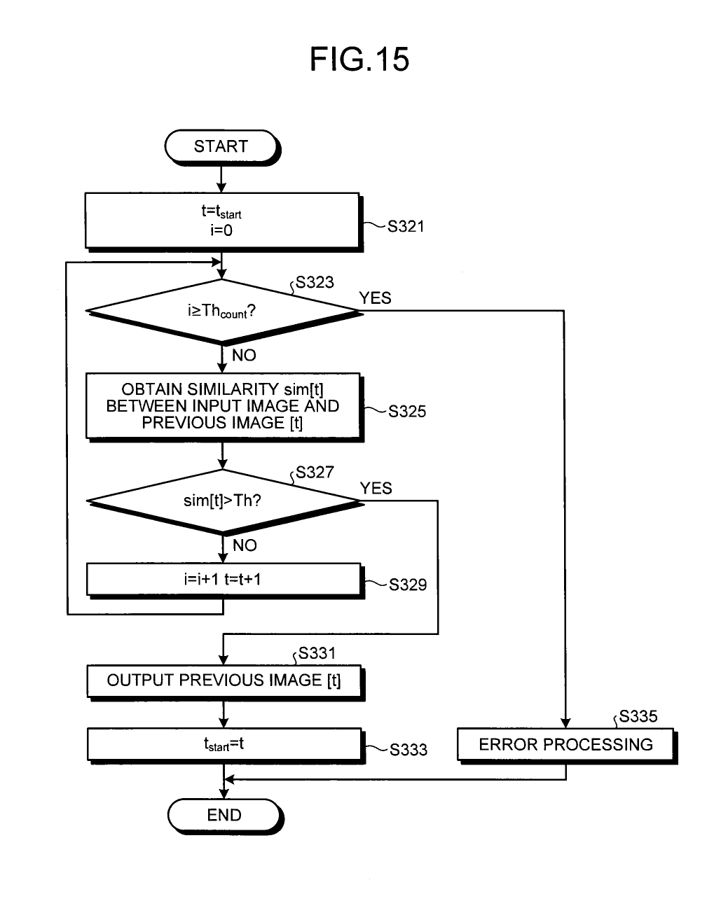

FIG. 15 is a flowchart illustrating another example of the flow of procedures of the second or subsequent search process performed by the searching unit 105 according to the first embodiment, in which details of step S105 of the flowchart illustrated in FIG. 11 are illustrated. Note that, in the example illustrated in FIG. 15, it is assumed that the searching unit 105 has acquired Th_{count} previous images in the order of time series from the previous image [tₛₜₐᵣₜ] as the time-series previous images among the time-series previous images stored in the previous image storage unit 103 in step S103 of the flowchart illustrated in FIG. 11. Alternatively, the searching unit 105 may set the beginning of the time-series previous images to be acquired to a previous image (a previous image [tₛₜₐᵣₜ−1] of one frame before, for example) captured some frames before the previous image [tₛₜₐᵣₜ] instead of the previous image [tₛₜₐᵣₜ]

First, the searching unit 105 initializes a variable t to the variable tₛₜₐᵣₜ and initializes a variable i to 0 (step S321). Herein, t is a variable for identifying a previous image, and i is a variable used as a count value. Note that, in the flowchart illustrated in FIG. 15, tₛₜₐᵣₜ is a variable start representing the previous image with the maximum similarity to the input image in the previous search process.

Subsequently, the searching unit 105 checks whether or not i≧Th_{count} is satisfied (step S323) and, if i≧Th_{count} is not satisfied (No in step S323), obtains the similarity sim[i] between the input image input from the image capturing unit 101 and a previous image [t] (step S325).

Subsequently, the searching unit 105 checks whether or not sim[t]>Th is satisfied (step S327) and, if sim[t]>Th is not satisfied (No in step S327), increments the variable i, increments the variable t (step S329), and returns to step S323.

If, on the other hand, sim[t]>Th is satisfied (Yes in step S327), the searching unit 105 outputs the previous image [t] as the predetermined previous image to the generating unit 107 (step S331), and updates the value of the variable tₛₜₐᵣₜ with the value of the variable t (step S333).

If i≧Th_{count} is satisfied in step S323 (Yes in step S323), the searching unit 105 performs error processing (step S335). Specifically, the searching unit 105 determines the previous image [t] as the predetermined previous image, outputs the previous image [t] with error information to the generating unit 107, and updates the value of the variable tₛₜₐᵣₜ with the value of the variable t.

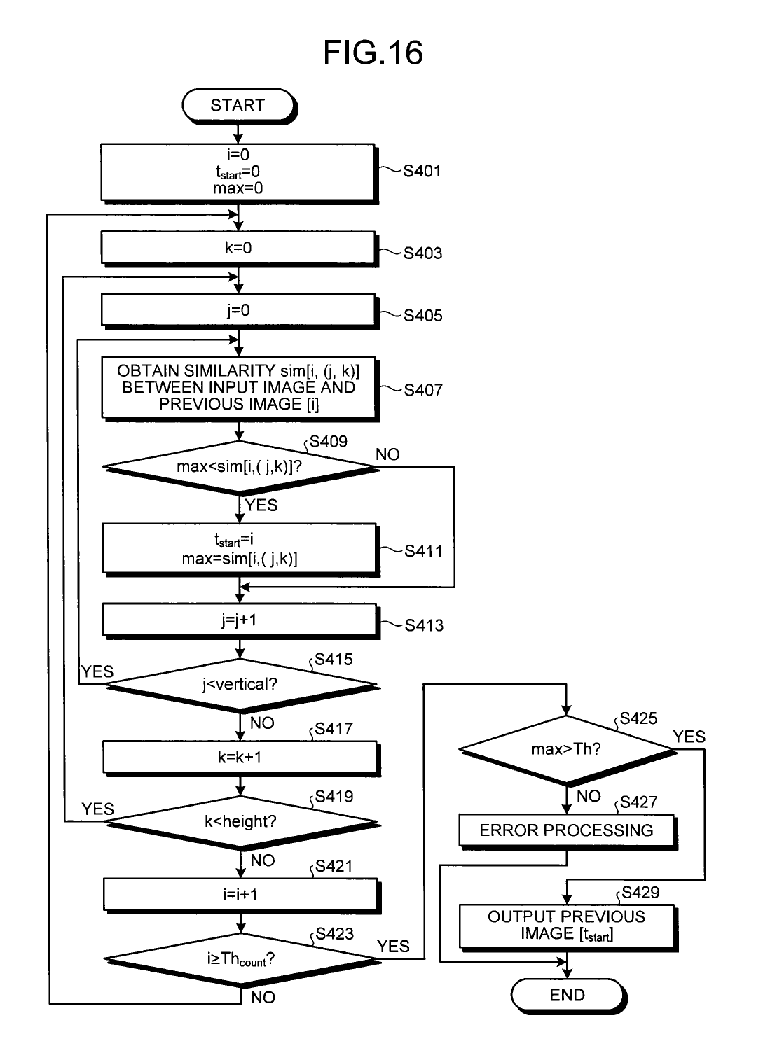

FIG. 16 is a flowchart illustrating another example of the flow of procedures of the first search process performed by the searching unit 105 according to the first embodiment, in which details of step S105 of the flowchart illustrated in FIG. 11 are illustrated. In the flowchart illustrated in FIG. 16, the similarity between partial regions of an input image and each of previous images is obtained, the maximum similarity is compared with the threshold, and the previous image with the maximum similarity is determined to be the predetermined previous image if the maximum similarity is equal to or higher than the threshold. Note that, in the example illustrated in FIG. 16, it is assumed that the searching unit 105 has acquired Th_{count} previous images in the order of time series from the first previous image [0] as the time-series previous images among the time-series previous images stored in the previous image storage unit 103 in step S103 of the flowchart illustrated in FIG. 11. In the first embodiment, the value of Th_{count} is set in advance.

First, the searching unit 105 initializes a variable i, a variable tₛₜₐᵣₜ, and a variable max to 0 (step S401). Herein, i is a variable representing both a parameter for identifying a previous image and a count value, tₛₜₐᵣₜ is a variable representing a previous image with the maximum similarity to the input image, and max is a variable representing the maximum value of the similarities between partial regions of the input image and partial regions of the previous image.

Subsequently, the searching unit 105 initializes a variable k to 0 (step S403), and initializes a variable j to 0 (step S405). Herein, k is a variable used as a parameter representing a position in the vertical direction of an input image and a previous image, and j is a variable used as a parameter representing a position in the lateral direction of the input image and the previous image.

Subsequently, the searching unit 105 obtains the similarity sim[i, (j, k)] between partial regions defined by the variable j and the variable k in the input image input from the image capturing unit 101 and a previous image [i] (step S407).

Subsequently, the searching unit 105 checks whether or not max<sim[i, (j, k)] is satisfied (step S409) and, if max<sim[i, (j, k)] is satisfied (Yes in step S409), updates the value of the variable tₛₜₐᵣₜ with the value of the variable i, and updates the value of the variable max with the value of the similarity sim[i, (j, k)] (step S411). If max<sim[i, (j, k)] is not satisfied (No in step S409), the searching unit 105 does not perform the processing in step S411.

Subsequently, the searching unit 105 increments the variable j (step S413), checks whether or not j<vertical is satisfied (step S415) and, if j<vertical is satisfied (Yes in step S415), returns to step S407. Herein, vertical represents the maximum value in the lateral direction of the input image and the previous image.

If, on the other hand, j<vertical is not satisfied (No in step S415), the searching unit 105 increments the variable k (step S417), checks whether or not k<height is satisfied (step S419) and, if k<height is satisfied (Yes in step S419), returns to step S405. Herein, height represents the maximum value in the vertical direction of the input image and the previous image.

If k<height is not satisfied (No in step S419), the searching unit 105 increments the variable i (step S421), checks whether or not i≧Th_{count} is satisfied (step S423) and, if i≧Th_{count} is not satisfied (No in step S423), returns to step S403.

If, on the other hand, i≧Th_{count} is satisfied (Yes in step S423), the searching unit 105 checks whether or not max>Th is satisfied (step S425). If max>Th is satisfied (Yes in step S425), the searching unit 105 outputs the previous image [tₛₜₐᵣₜ] as the predetermined previous image to the generating unit 107 (step S429). Herein, Th is the threshold for the similarity.

If max>Th is not satisfied (No in step S425), the searching unit 105 performs error processing (step S427). Specifically, the searching unit 105 determines the previous image [tₛₜₐᵣₜ] as the predetermined previous image, and outputs the previous image [tₛₜₐᵣₜ] with error information to the generating unit 107.

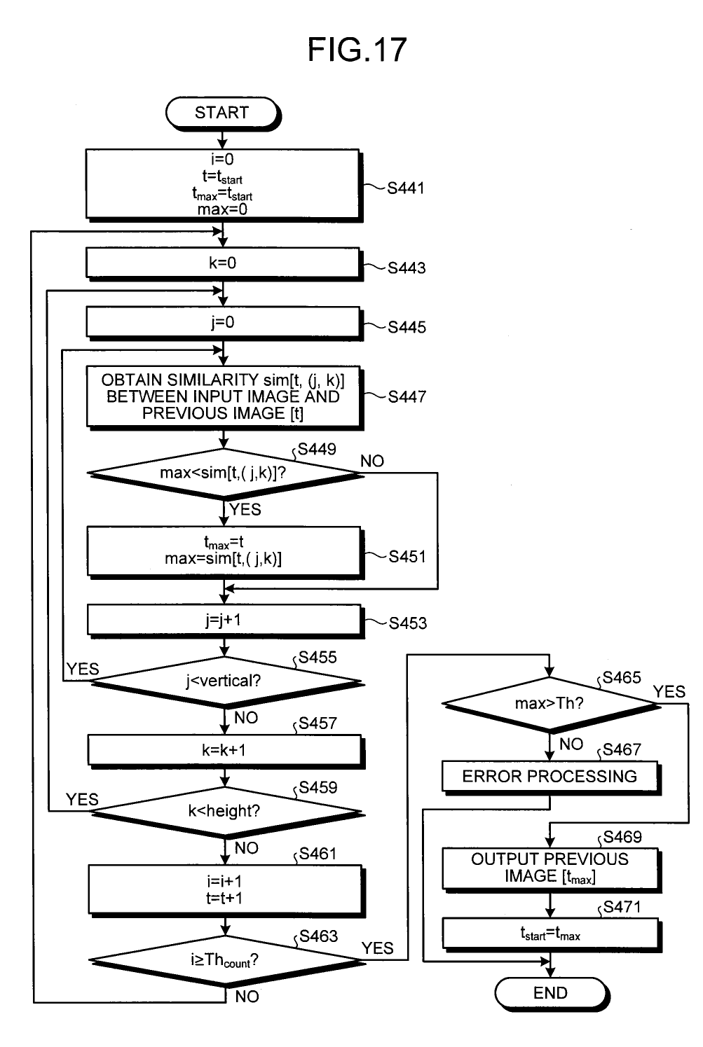

FIG. 17 is a flowchart illustrating another example of the flow of procedures of the second or subsequent search process performed by the searching unit 105 according to the first embodiment, in which details of step S105 of the flowchart illustrated in FIG. 11 are illustrated. Note that, in the example illustrated in FIG. 17, it is assumed that the searching unit 105 has acquired Th_{count}1 previous images in the order of time series from the previous image [tₛₜₐᵣₜ] as the time-series previous images among the time-series previous images stored in the previous image storage unit 103 in step S103 of the flowchart illustrated in FIG. 11. Alternatively, the searching unit 105 may set the beginning of the time-series previous images to be acquired to a previous image (a previous image [tₛₜₐᵣₜ−1] of one frame before, for example) captured some frames before the previous image [tₛₜₐᵣₜ] instead of the previous image [tₛₜₐᵣₜ].

First, the searching unit 105 initializes a variable i and a variable max to 0, and initializes a variable t and a variable tₘₐₓ to the variable tₛₜₐᵣₜ (step S441). Herein, i is a variable used as a count value, t is a variable for identifying a previous image, and tₘₐₓ is a variable representing a previous image with the maximum similarity to the input image. Note that, in the flowchart illustrated in FIG. 17, tₛₜₐᵣₜ is a variable representing the previous image with the maximum similarity to the input image in the previous search process.

Subsequently, the searching unit 105 initializes a variable k to 0 (step S443), and initializes a variable j to 0 (step S445).

Subsequently, the searching unit 105 obtains the similarity sim[i, (j, k)] between partial regions defined by the variable j and the variable k in the input image input from the image capturing unit 101 and a previous image [t] (step S447).

Subsequently, the searching unit 105 checks whether or not max<sim[t, (j, k)] is satisfied (step S449) and, if max<sim[t, (j, k)] is satisfied (Yes in step S449), updates the value of the variable tₘₐₓ with the value of the variable t, and updates the value of the variable max with the value of the similarity sim[t, (j, k)] (step S451). If max<sim[t, (j, k)] is not satisfied (No in step S449), the searching unit 105 does not perform the processing in step S451.

Subsequently, the searching unit 105 increments the variable j (step S453), checks whether or not j<vertical is satisfied (step S455) and, if j<vertical is satisfied (Yes in step S455), returns to step S447.

If, on the other hand, j<vertical is not satisfied (No in step S455), the searching unit 105 increments the variable k (step S457), checks whether or not k<height is satisfied (step S459) and, if k<height is satisfied (Yes in step S459), returns to step S445.

If k<height is not satisfied (No in step S459), the searching unit 105 increments the variable i, increments the variable t (step S461), checks whether or not i≧Th_{count} is satisfied (step S463) and, if i≧Th_{count} is not satisfied (No in step S463), returns to step S443.

If, on the other hand, i≧Th_{count} is satisfied (Yes in step S463), the searching unit 105 checks whether or not max>Th is satisfied (step S465). If max>Th is satisfied (Yes in step S465), the searching unit 105 outputs the previous image [tₘₐₓ] as the predetermined previous image to the generating unit 107 (step S469) and updates the value of the variable tₛₜₐᵣₜ with the value of the variable tₘₐₓ (step S471).

If max>Th is not satisfied (No in step S465), the searching unit 105 performs error processing (step S467). Specifically, the searching unit 105 determines the previous image [tₘₐₓ] as the predetermined previous image, outputs the previous image [tₘₐₓ] with error information to the generating unit 107, and updates the value of the variable tₛₜₐᵣₜ with the value of the variable tₘₐₓ.

As described above, according to the first embodiment, since images are synchronized according to the similarity, images captured arbitrarily can be synchronized, and the first embodiment is therefore suitable for such applications as inspection of a route on which a mobile object runs. For example, display of a synchronized image of an input image and a previous image allows the user (inspector) to easily detect abnormality by visual observation and to easily check a change in the route.

In particular, according to the first embodiment, input images and previous images can be synchronized even if the running speed of the mobile object while the time-series previous images are captured and the running speed of the mobile object while the input images are captured are different.

In the first embodiment, the case in which the running speed of the mobile object while the time-series previous images are captured is lower than the running speed of the mobile object while the input images are captured has been described (see FIGS. 2 and 3). In this case, since the number of frames of the previous images is smaller than that of the input images, the association of the input images with the previous images being M:1, the image synchronization device 100 (the searching unit 105) uses the same previous image a plurality of times and performs frame interpolation to synchronize the previous images with the input images (see FIG. 4). Note that the image synchronization device 100 (the searching unit 105) may generate an interpolation image from previous and next images instead of performing frame interpolation to synchronize the previous images with the input images.

If, on the other hand, the running speed of the mobile object while the time-series previous images are captured is lower than the running speed of the mobile object while the input images are captured, the number of frames of the previous images is larger than that of the input images, the association of the input images with the previous images being 1:1. Accordingly, the image synchronization device 100 (the searching unit 105) skips frames of the previous images to synchronize the previous images with the input images.

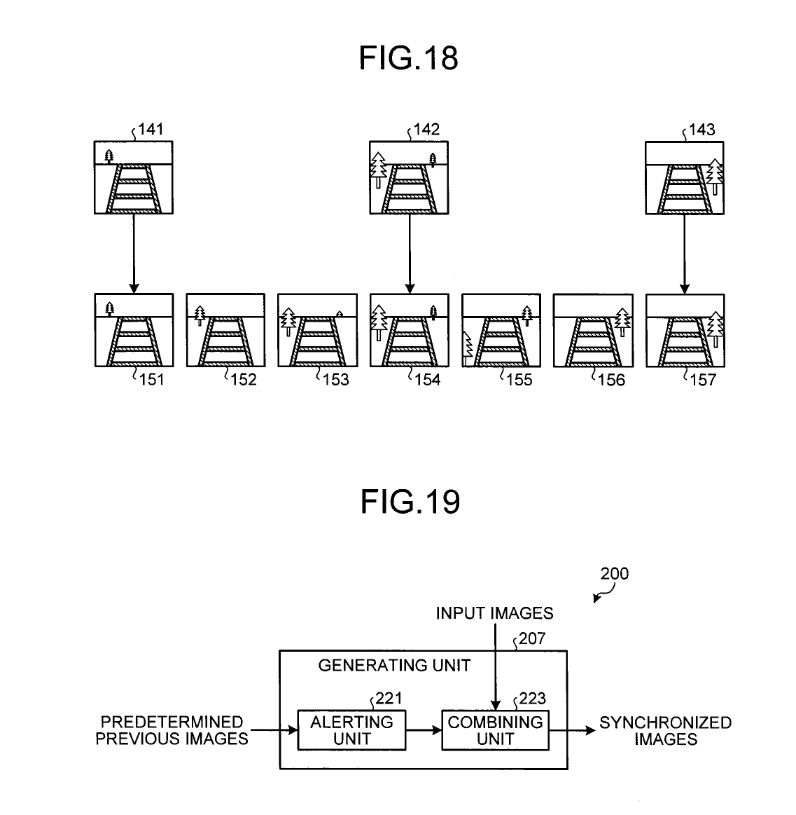

FIG. 18 is a diagram illustrating an example of a result of searching for predetermined previous images in a case where the number of frames of the previous images is larger than that of input images in the first embodiment. Note that, in FIG. 18, description will be made assuming that images 141 to 143 are input images and images 151 to 157 are previous images. In the example illustrated in FIG. 18, the predetermined previous image for the input image 141 is the previous image 151, the predetermined previous image for the input image 142 is the previous image 154, the predetermined previous image for the input image 143 is the previous image 157, and the previous images 152, 153, 155 and 156 are not synchronized with the input images.

### Second Embodiment

In the second embodiment, an example in which, if the similarity of a predetermined previous images is lower than a threshold, the information is informed will be described. In the following, the difference from the first embodiment will be mainly described and components having similar functions as in the first embodiment will be designated by the same names and reference numerals as in the first embodiment, and the description thereof will not be repeated.

FIG. 19 is a diagram illustrating an example of the configuration of a generating unit 207 in an image synchronization device 200 according to the second embodiment. As illustrated in FIG. 19, the generating unit 207 according to the second embodiment is different from that in the first embodiment in that the generating unit 207 includes an alerting unit 221 and a combining unit 223.

The generating unit 207 generates a synchronized image indicating that the similarity of a predetermined previous image is lower than the threshold. Specifically, the alerting unit 221 detects that error information is added to a predetermined previous image output from the searching unit 105. The combining unit 223 generates a synchronized image by using the input image and the predetermined previous image. If error information is detected by the alerting unit 221, the combining unit 223 combines an image indicating an alert (warning) with the predetermined previous image when generating a synchronized image. Alternatively, if error information is detected by the alerting unit 221, the combining unit 223 may combine an image indicating an alert with the input image instead of the predetermined previous image when generating a synchronized image. If the error information is added to the input image instead of the predetermined previous image, the configuration may be such that the input image is input to the alerting unit 221 and the predetermined previous image is input to the combining unit 223.

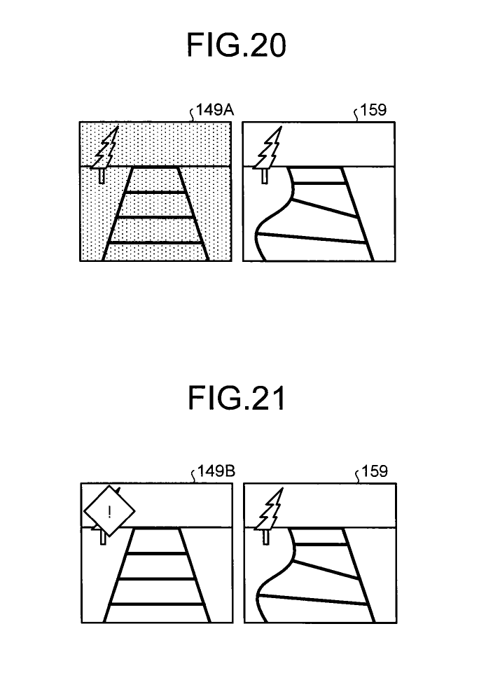

FIGS. 20 and 21 are diagrams illustrating examples of the synchronized images according to the second embodiment. In a synchronized image illustrated in FIG. 20, a predetermined previous image 149A includes a previous image 149 added with error information and a color image such as red combined therewith so as to alert that the similarity to the input image is lower than the threshold. In a synchronized image illustrated in FIG. 21, a predetermined previous image 149B includes a previous image 149 added with error information and an alert image combined therewith so as to alert that the similarity to the input image is lower than the threshold.

Note that, for a previous image such as the previous image 141 to which no error information is added, the generating unit 207 generates a synchronized image as described with reference to FIGS. 5 and 6, for example, and does not make alert indication using the predetermined previous image.

If the similarity of a predetermined previous image found by the searching unit 105 is lower than the threshold, the output unit 109 informs of the information. Specifically, the output unit 109 outputs for display a synchronized image indicating that the similarity of the predetermined previous image is lower than the threshold.

As described above, according to the second embodiment, since alert indication is made in the synchronized image for a predetermined previous image with the similarity to the input image lower than the threshold, the user (inspector) can very easily detect abnormality by visual observation.

Although the example in which an alert is made by a display output is described in the second embodiment, an alert may be made by audio output.

### Third Embodiment

In the third embodiment, an example in which the number of previous images included in the time-series previous images is determined according to the ratio of the speed of the mobile object while input images are captured to that while previous images are captured will be described. In the following, the difference from the first embodiment will be mainly described and components having similar functions as in the first embodiment will be designated by the same names and reference numerals as in the first embodiment, and the description thereof will not be repeated.

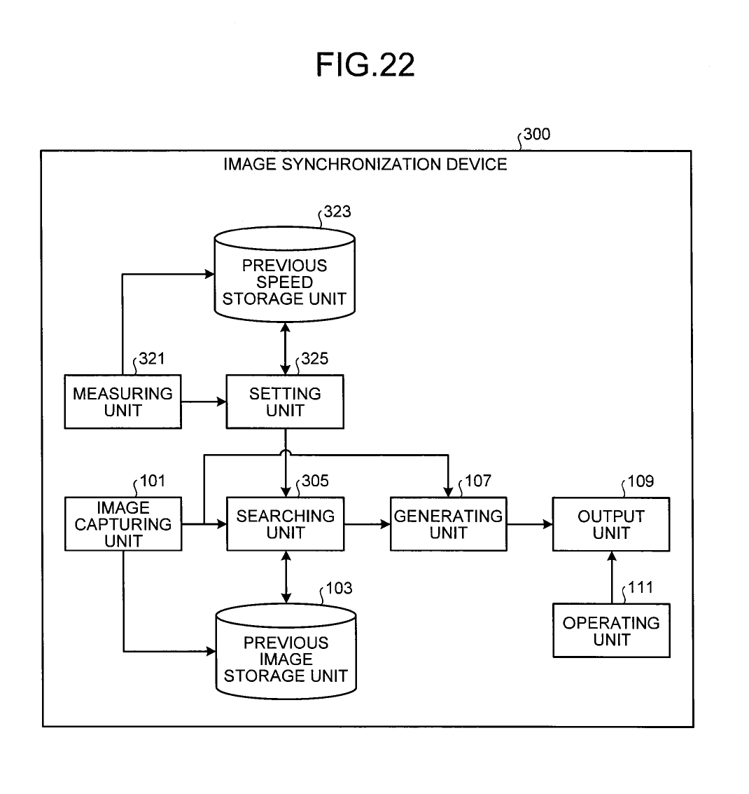

FIG. 22 is a diagram illustrating an example of the configuration of an image synchronization device 300 according to the third embodiment. As illustrated in FIG. 22, the image synchronization device 300 according to the third embodiment is different to that in the first embodiment in further including a measuring unit 321, a previous speed storage unit 323, and a setting unit 325 and in a searching unit 305.

The measuring unit 321 can be realized by a measuring device capable of measuring speed such as a speed sensor, for example. The previous speed storage unit 323 can be realized by a storage device that can magnetically, optically or electrically store information such as an HDD, an SSD, a memory card, an optical disk, or a RAM, for example. The setting unit 325 may be implemented by making a processor such as a CPU execute a program, that is, by software, may be implemented by hardware such as an IC, or may be implemented by combination of software and hardware, for example.

The measuring unit 321 measures the running speed of the mobile object on which the image capturing unit 101 is mounted. Specifically, the measuring unit 321 measures in advance a previous speed (an example of a second speed) that is the running speed of the mobile object while time-series previous images are captured, and measures a current speed (an example of a first speed) that is the running speed of a train while input images are captured.

The previous speed storage unit 323 stores speed information indicating the previous speed measured by the measuring unit 321.

The setting unit 325 acquires the speed information from the previous speed storage unit 323, and sets the number of second images included in the time-series second images according to the current speed measured by the measuring unit 321 and the previous speed indicated by the speed information.

For example, if the running speed of the mobile object while the time-series previous images are captured is lower than that while the input images are captured, a plurality of frames of the time-series previous images are captured in a period corresponding to one frame while the input images are captured, the number of frames of the captured previous images corresponding to the ratio of the running speed of the mobile object while the previous images are captured to that while the input images are captured.

In other words, when the frame of an input image x is associated with the frame of a previous image y, the frame of an input image (x+1) will be associated with the frame of a previous image (y+speed ratio). For example, in the example illustrated in FIG. 18, since the running speed of the mobile object while the input images are captured is three times the running speed of the object while the time-series previous images are captured, the frame of an input image (x+1) will be associated with the frame of a previous image (y+3) when the frame of an input image x is associated with the frame of a previous image y.

Accordingly, when the running speed of the mobile object while the time-series previous images are captured is lower than that while the input images are captured, the setting unit 325 needs to set the number of second images to be included in the second images in time series to a value equal to or larger than the speed ratio.

If, on the other hand, the running speed of the mobile object while the time-series previous images are captured is higher than that while the input images are captured, the frame of an input image (x+1) will be associated with the frame of a previous image (y+1) when the frame of an input image x is associated with the frame of a previous image y.

Accordingly, when the running speed of the mobile object while the time-series previous images are captured is higher than that while the input images are captured, the setting unit 325 may set the number of second images to be included in the time-series second images to about two.

Each time an input image is input from the image capturing unit 101, the searching unit 305 acquires the time-series previous images, the number of the acquired previous images being set by the setting unit 325, in the order of time series from the predetermined previous image found last time as the time-series previous images from the previous image storage unit 103, and obtains the similarity between the input image and each of the previous images to search for a predetermined previous image with the similarity equal to or higher than a threshold.

As described above, according to the third embodiment, since the number of second images to be included in the time-series second images can be optimized, the time required for the image synchronization process can be shortened.

### Fourth Embodiment

In the fourth embodiment, an example in which the similarity to a previous image is obtained for a non-abnormal region in an input image to perform synchronization will be described. In the following, the difference from the first embodiment will be mainly described and components having similar functions as in the first embodiment will be designated by the same names and reference numerals as in the first embodiment, and the description thereof will not be repeated.

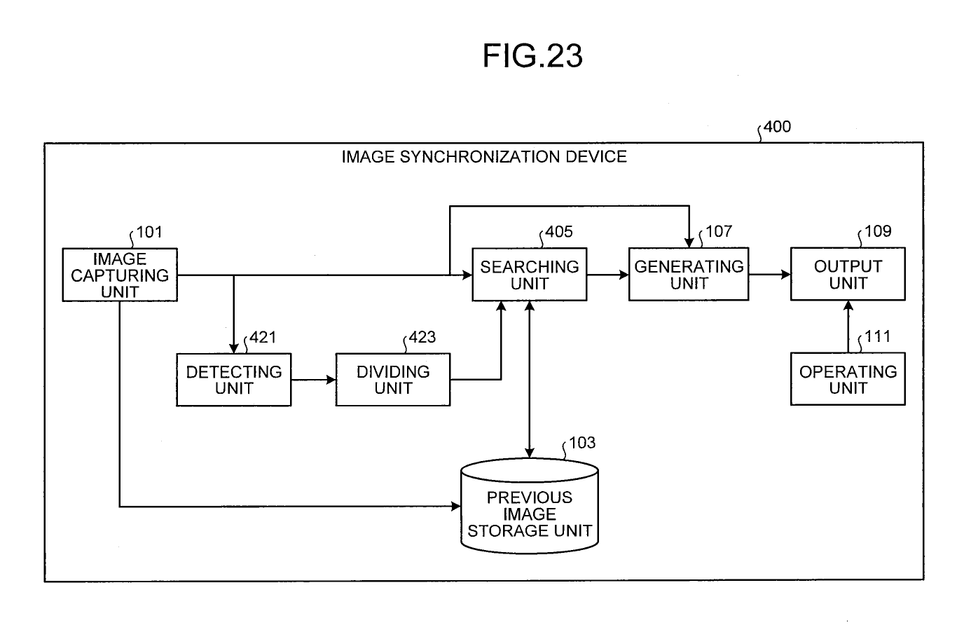

FIG. 23 is a diagram illustrating an example of the configuration of an image synchronization device 400 according to the fourth embodiment. As illustrated in FIG. 23, the image synchronization device 400 according to the fourth embodiment is different from that in the first embodiment in further including a detecting unit 421 and a dividing unit 423 and in a searching unit 405.

The detecting unit 421 can be realized by a detecting device capable of detecting abnormality such as a laser sensor, an infrared sensor, a far-infrared sensor, an ultrasonic sensor, or a tactile sensor, for example. The dividing unit 423 may be implemented by making a processor such as a CPU execute a program, that is, by software, may be implemented by hardware such as an IC, or may be implemented by combination of software and hardware, for example.

The detecting unit 421 detects an abnormal region from an input image input from the image capturing unit 101. Specifically, the detecting unit 421 is mounted on the mobile object on which the image capturing unit 101 is mounted, and detects an abnormal region in an input image by detecting abnormality in a region captured by the image capturing unit 101.

If the detecting unit 421 detects something that makes it difficult for the mobile object to run normally or something that has not existed such as damage, a rise, or the presence of an obstacle on the route (a track or a road, for example) in a region captured by the image capturing unit 101, for example, the detecting unit 421 detects a region in which the thing is present in the input image as an abnormal region.

The dividing unit 423 divides the input image into an abnormal region detected by the detecting unit 421 and a non-abnormal region that is a region other than the abnormal region.

The searching unit 405 acquires the time-series previous images, and obtains the similarity for the non-abnormal regions between the input image and each of the previous images.

As described above, according to the fourth embodiment, since the similarity between an input image and a previous image is obtained for a non-abnormal region in which no abnormality occurs, the input images and the previous images can be synchronized without being affected by abnormality occurring on the route.

If an abnormal region is detected from an input image by the detecting unit 421, the generating unit 107 may indicate that the abnormality is detected in a synchronized image generated by using the input image. In this manner, the user can very easily detect abnormality by visual observation.

### Fifth Embodiment

In the fifth embodiment, an example in which input image is obtained by decoding encoded data of image captured will be described. In the following, the difference from the first embodiment will be mainly described and components having similar functions as in the first embodiment will be designated by the same names and reference numerals as in the first embodiment, and the description thereof will not be repeated.

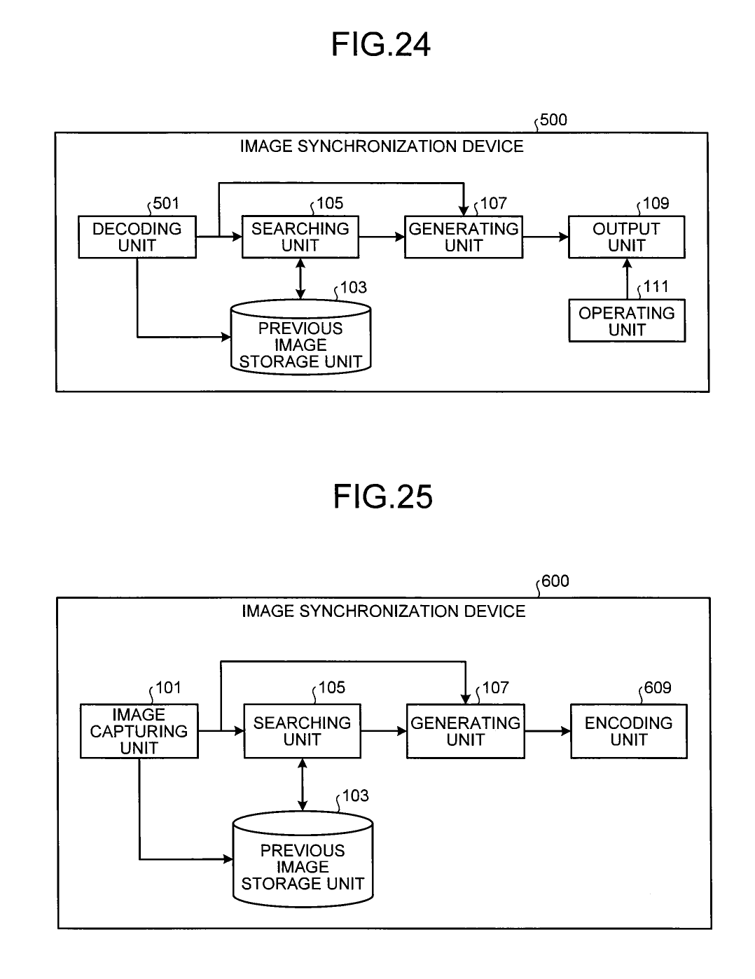

FIG. 24 is a diagram illustrating an example of the configuration of an image synchronization device 500 according to the fifth embodiment. As illustrated in FIG. 24, the image synchronization device 500 according to the fifth embodiment is different from that in the first embodiment in including a decoding unit 501 instead of the image capturing unit 101.

The decoding unit 501 may be implemented by making a processor such as a CPU execute a program, that is, by software, may be implemented by hardware such as an IC, or may be implemented by combination of software and hardware, for example.

The decoding unit 501 decodes encoded data of images captured by an image capturing unit mounted on a mobile object while the mobile object is running on a route, and inputs the decoded data as input images to the searching unit 105.

As described above, according to the fifth embodiment, the same effects as in the first embodiment can be produced even when encoded data are input.

### Sixth Embodiment

In the sixth embodiment, an example in which a synchronized image is encoded instead of outputting the synchronized image will be described. In the following, the difference from the first embodiment will be mainly described and components having similar functions as in the first embodiment will be designated by the same names and reference numerals as in the first embodiment, and the description thereof will not be repeated.

FIG. 25 is a diagram illustrating an example of the configuration of an image synchronization device 600 according to the sixth embodiment. As illustrated in FIG. 25, in the image synchronization device 600 according to the sixth embodiment, the output unit 109 functions as an encoding unit 609.

The encoding unit 609 may be implemented by making a processor such as a CPU execute a program, that is, by software, may be implemented by hardware such as an IC, or may be implemented by combination of software and hardware, for example.

The encoding unit 609 encodes a synchronized image generated by the generating unit 107.

As described above, since a synchronized image is encoded according to the sixth embodiment, the sixth embodiment is suitable when a synchronized image is transferred to another device and output therefrom.

### Seventh Embodiment

In the seventh embodiment, an image synchronization system will be described. In the following, the difference from the first embodiment will be mainly described and components having similar functions as in the first embodiment will be designated by the same names and reference numerals as in the first embodiment, and the description thereof will not be repeated.

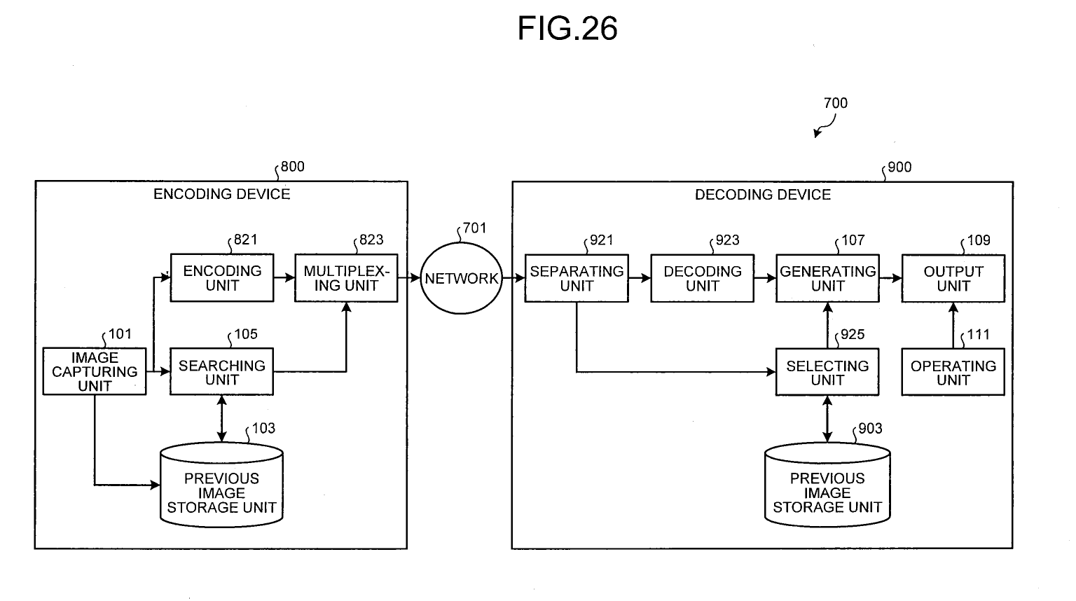

FIG. 26 is a diagram illustrating an example of the configuration of an image synchronization system 700 according to the seventh embodiment. As illustrated in FIG. 26, the image synchronization system 700 according to the seventh embodiment includes an encoding device 800 and a decoding device 900. The encoding device 800 and the decoding device 900 are connected via a network 701. The network 701 can be realized by a local area network (LAN) or the Internet, for example.

As illustrated in FIG. 26, the encoding device 800 includes an image capturing unit 101, a previous image storage unit 103, a searching unit 105, an encoding unit 821, and a multiplexing unit 823.

The image capturing unit 101, the previous image storage unit 103, and the searching unit 105 are the same as those in the first embodiment. The encoding unit 821 and the multiplexing unit 823 may be implemented by making a processor such as a CPU execute a program, that is, by software, may be implemented by hardware such as an IC, or may be implemented by combination of software and hardware, for example.

The encoding unit 821 encodes an input image input from the image capturing unit 101 to obtain encoded data.

The multiplexing unit 823 multiplexes the encoded data obtained by the encoding unit 821 and an index of a predetermined previous image found by the searching unit 105 to obtain multiplex data. The multiplexing unit 823 then transmits the multiplexed data to the decoding device 900 via the network 701.

As illustrated in FIG. 26, the decoding device 900 includes a previous image storage unit 903, a separating unit 921, a decoding unit 923, a selecting unit 925, a generating unit 107, an output unit 109, and an operating unit 111.

The generating unit 107, the output unit 109, and the operating unit 111 are the same as those in the first embodiment. The previous image storage unit 903 is the same as the previous image storage unit 103. The separating unit 921, the decoding unit 923, and the selecting unit 925 may be implemented by making a processor such as a CPU execute a program, that is, by software, may be implemented by hardware such as an IC, or may be implemented by combination of software and hardware, for example.

The separating unit 921 receives the multiplexed data from the encoding device 800 via the network 701. The separating unit 921 then separates (demultiplexes) the received multiplexed data into the encoded data and the index.

The decoding unit 923 decodes the encoded data obtained by the separation by the separating unit 921 to obtain an input image.

The selecting unit 925 selects a predetermined previous image from the previous image storage unit 903 by using the index obtained by the separation by the separating unit 921.

As described above, according to the seventh embodiment, the amount of data to be transferred via the network can be significantly reduced when synchronized images are output by another device.

Hardware Configuration

An example of the hardware configuration of the image synchronization device according to the embodiments described above will be described. The image synchronization device according to the embodiments described above includes a control unit such as a CPU, a storage unit such as a ROM and a RAM, an external storage unit such as a HDD, a display unit such as a display, an input device such as a keyboard and a mouse, and a communication unit such as a communication interface, which is a hardware configuration utilizing a common computer system.

Programs to be executed by the image synchronization device according to the embodiments described above are stored on a computer readable recording medium such as a CD-ROM, a CD-R, a memory card, a digital versatile disk (DVD) and a flexible disk (FD) in a form of a file that can be installed or executed, and provided therefrom.

Alternatively, the programs to be executed by the image synchronization device according to the embodiments described above may be stored on a computer system connected to a network such as the Internet, and provided by being downloaded via the network. Still alternatively, the programs to be executed by the image synchronization device according to the embodiments described above may be provided or distributed through a network such as the Internet. Still alternatively, the programs to be executed by the image synchronization device according to the embodiments described above may be embedded in a ROM or the like in advance and provided therefrom.

The programs to be executed by the image synchronization device according to the embodiments described above have modular structures for implementing the respective units described above on a computer system. In an actual hardware configuration, the CPU reads programs from the HDD and executes the programs on the RAM, whereby the respective units described above are implemented on a computer system.

Note that the present invention is not limited to the embodiments presented above, but may be embodied with various modified components in implementation thereof without departing from the scope of the invention. Furthermore, the invention can be embodied in various forms by appropriately combining a plurality of components disclosed in the embodiments. For example, some of the components presented in the embodiments may be omitted. Furthermore, the components in different embodiments may be appropriately combined.

For example, the order in which the steps in the flowcharts in the embodiments described above are performed may be changed, a plurality of steps may be performed at the same time or the order in which the steps are performed may be changed each time the steps are performed to the extent that the changes are not inconsistent with the nature thereof.

As described above, according to the embodiments, even images that are arbitrarily captured can be synchronized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image synchronization device comprising:
an image capturing unit configured to capture a first image while a mobile object on which the image capturing unit is mounted is running on a route;
a searching unit configured to
acquire time-series second images captured by the image capturing unit while the mobile object was previously running on the route,
obtain similarity between the first image and each of the second images, and
search for a specific second image with the similarity satisfying criteria for select; and
an output unit configured to output a synchronized image based on the first image and the specific second image.

2. The device according to claim 1, wherein the searching unit searches for the specific second image with the similarity equal to or higher than a threshold.

3. The device according to claim 1, wherein the searching unit searches for specific second image with a maximum similarity.

4. The device according to claim 1, further comprising a generating unit configured to generate the synchronized image by using the first image and the specific second image.

5. The device according to claim 2, wherein when a second image with the similarity equal to or higher than the threshold is not found, the searching unit determines a second image with a maximum similarity as the specific second image.

6. The device according to claim 5, wherein when the similarity of the specific second image is lower than the threshold, the output unit notifies that the similarity of the specific second image is lower than the threshold.

7. The device according to claim 6, wherein
the generating unit generates the synchronized image indicating that the similarity of the specific second image is lower than the threshold, and
the output unit outputs the synchronized image.

8. The device according to claim 1, further comprising:
a measuring unit configured to measure a first speed that is a running speed of the mobile object at a time when the first image is captured; and
a setting unit configured to
acquire speed information indicating a second speed that is a running speed of the mobile object at a time when the time-series second images are captured, and
set the number of second images to be included in the time-series second images according to the first speed and the second speed, the second speed being measured by the measuring unit.

9. The device according to claim 1, further comprising:
a detecting unit configured to detect an abnormal region from the first image; and
a dividing unit configured to divide the first image into the abnormal region and a non-abnormal region, wherein
the searching unit acquires the time-series second images and obtains similarity between the non-abnormal regions of the first image and each of the second images.

10. The device according to claim 1, wherein
the image capturing unit sequentially captures first images,
the searching unit acquires time-series second images for each of the first images, obtains similarity between the first image and each of the acquired second images, and searches for a specific second image with the similarity equal to or higher than a threshold, and
the output unit outputs the synchronized image based on the first image and the specific second image for each of the first images.

11. The device according to claim 1, wherein the output unit encodes the synchronized image.

12. An image synchronization device comprising:
a decoding unit configured to decode encoded data of a first image captured by an image capturing unit mounted on a mobile object that runs on a route while the mobile object is running on the route;
a searching unit configured to
acquire time-series second images captured by the image capturing unit while the mobile object was previously running on the route,
obtain similarity between the decoded first image and each of the second images, and
search for a specific second image with the similarity satisfying criteria for select; and
an output unit configured to output a synchronized image based on the first image and the specific second image.

13. An image synchronization system comprising an encoding device and a decoding device, wherein
the encoding device includes
an image capturing unit configured to capture a first image while the mobile object on which the image capturing unit is mounted is running on a route;
a searching unit configured to
acquire time-series second images captured by the image capturing unit while the mobile object was previously running on the route,
obtain similarity between the first image and each of the second images, and
search for a specific second image with the similarity satisfying criteria for select;
an encoding unit configured to encode the first image to obtain encoded data; and
a multiplexing unit configured to multiplex the encoded data and an index of the specific second image to obtain multiplexed data, and
the decoding device includes
a demultiplexing unit configured to demultiplex the multiplexed data into the encoded data and the index;
a decoding unit configured to decode the encoded data to obtain the first image;
a selecting unit configured to select the specific second image by using the index; and
an output unit configured to output a synchronized image based on the first image and the specific second image.
